(19) United States
(12) Patent Application Publication
(10) Pub. No.: US 2007/0291607 A1
(43) Pub. Date: Dec. 20, 2007

(54) Recording Device and Method, and Computer Program

(75) Inventors: Keiji Katata, Saitama (JP); Tatsuhiko Ono, Saitama (JP)

Correspondence Address: YOUNG & THOMPSON, 745 SOUTH 23RD STREET, 2ND FLOOR, ARLINGTON, VA, 22202, US

(73) Assignee: Pioneer Corporation, Tokyo (JP)

(21) Appl. No.: 11/663,282

(22) PCT Filed: Sep. 21, 2005
(86) PCT No.: PCT/JP05/17355

§ 371 Date: May 22, 2007

(30) Foreign Application Priority Data
Sep. 21, 2004 (JP) 2004-273107

(51) Int. Cl. G11B 7/0037

(52) U.S. Cl. 369/53.15

(57) ABSTRACT

A recording apparatus (200) is provided with: a backup device (352) for backing up data recorded on one recording medium (455) onto another recording medium (100); a verifying device (359) for verifying presence or absence of a defect in at least a recording area in which the data is backed up, out of the another recording medium; a selecting device (362) for selecting a verification mode used in verifying the presence or absence of the defect, depending on characteristics of the data to be backed up; and a controlling device (361) for controlling the verifying device to verify the presence or absence of the defect in the selected verification mode.

### TECHNICAL FIELD

The present invention relates to a recording apparatus and method, such as, for example, a DVD recorder, and a computer program which makes a computer function as the information recording apparatus.

### BACKGROUND ART

As a technology to improve the reliability of data recording and reading on a high-density recording medium, such as an optical disc, a magnetic disk, and a magneto optical disc, there is defect management. Namely, if there are scratches or dusts, or deterioration (generically referred to as a “defect”) on the recording medium, data to be recorded or already recorded at the position of the defect is recorded into another area on the recording medium (referred to as a “spare area”). In this manner, by evacuating, to the spare area, the data which is possibly imperfectly or incompletely recorded or read because of the defect, it is possible to improve the reliability of the data recording and reading (refer to a patent document 1).

On the other hand, in order to back up various data, the optical disc as mentioned above or the like is often used. In particular, on a large-capacity optical disc or the like, it is possible to back up all the data recorded on a recording medium, such as a hard disk, provided for a PC or the like. Thus, it has such an advantage that it is easily used for backup application. Moreover, there has been also developed a technology not only to back up data just as a copy, but also to selectively back up updated data and newly recorded data, by comparing the name and recording date of the data recorded on a recording medium as a backup source with those of the data recorded on a recording medium as a backup destination. Even in the backup operation for such data, the defect management can be performed in order to improve the reliability of the data recording and reading.
Patent document 1: Japanese Patent Application Laying Open NO. Hei 11-185390

### DISCLOSURE OF INVENTION

Subject to be Solved by the Invention

However, in the backup operation, it is necessary to back up relatively large volumes of data. Thus, verifying whether or not there is the defect in all the recording areas in which the data will be recorded may cause such a disadvantage that a backup time is greatly increased. For example, if the data recorded on a hard disk in which several tens GB data can be recorded is backed up while verifying the presence or absence of the defect, it may take 10 hours in some cases. This possibly makes a user unmotivated to back up the data, and it is not preferable. However, in order to avoid the disadvantage, if the data is backed up without any verification of the presence or absence of the defect, the reliability of the data recording and reading is reduced, so that it is not preferable.

It is therefore an object of the present invention to provide a recording apparatus and method which are operable to quickly back up data while increasing the reliability of data recording and reading, as well as a computer program which makes a computer function as such a recording apparatus.

Means for Solving the Subject

(Recording Apparatus)

The above object of the present invention can be achieved by a recording apparatus provided with: a backup device for backing up data recorded on one recording medium onto another recording medium; a verifying device for verifying presence or absence of a defect in at least a recording area in which the data is backed up, out of the another recording medium; a selecting device for selecting a verification mode used in verifying the presence or absence of the defect, depending on characteristics of the data to be backed up; and a controlling device for controlling the verifying device to verify the presence or absence of the defect in the selected verification mode.

According to the recording apparatus of the present invention, by virtue of the operation of the backup device, the data recorded on one recording medium can be backed up onto another recording medium. Here, the term “backup” in the present invention indicates the overall operation of recording the data recorded on one recording medium onto another recording medium, and broadly includes so-called “copy”. At this time, by virtue of the operation of the verifying device, the presence or absence of the defect is verified in the recording area in which the data is backed up (i.e. the data is recorded by the backup device), out of the another recording medium which is a backup destination. Namely, it is judged whether or not there is the defect.

Particularly in the present invention, before or simultaneously with the verification operation performed by the verifying device, a predetermined verification mode for defining the aspect of the verification operation is selected by the selecting device. Specifically, depending on the characteristics of the data to be backed up, one of a plurality of verification modes is selected. Then, by virtue of the operation of the controlling device, the verifying device is controlled to perform the defect verification operation based on the selected one verification mode.

Specifically, one verification mode is selected so as to perform, for example, the defect verification operation in which a time necessary to back up the data can be relatively reduced. Alternatively, one verification mode is selected so as to perform, for example, the defect verification operation in which the reliability of data recording and reading can be relatively improved.

As described above, since the aspect of the defect verification operation can be changed as occasion demands, the time necessary to perform the backup or the reliability of data recording and reading can be set as a desired value. Therefore, depending on the characteristics of the data to be backed up, priority is given to reducing the time necessary for the backup, or priority is given to improving the reliability of data recording and reading. Of course, priority is given to both reducing the time necessary for the backup, and improving the reliability of data recording and reading.

Consequently, according to the recording apparatus of the present invention, the reliability of data recording and reading can be improved, with reducing the time necessary to back up the data.

In one aspect of the recording apparatus of the present invention, the selecting device selects the verification mode, depending on a data type of the data, as the characteristics.

According to this aspect, depending on the data type of the data (e.g. as described later, such a data type as text data, image data, and motion picture data), it is possible to select, for example, the verification mode in which priority is given to reducing the time necessary to back up the data, or the verification mode in which priority is given to improving the reliability of data recording and reading.

In another aspect of the recording apparatus of the present invention, the selecting device selects the verification mode, depending on a size of the data, as the characteristics.

According to this aspect, depending on the size of the data, it is possible to select, for example, the verification mode in which priority is given to reducing the time necessary to back up the data, or the verification mode in which priority is given to improving the reliability of data recording and reading.

In another aspect of the recording apparatus of the present invention, the selecting device selects the verification mode, depending on an intended purpose of the data, as the characteristics.

According to this aspect, depending on the intended purpose of the data (e.g. as described later, such an intended purpose as for business and for private), it is possible to select, for example, the verification mode in which priority is given to reducing the time necessary to back up the data, or the verification mode in which priority is given to improving the reliability of data recording and reading.

In another aspect of the recording apparatus of the present invention, the selecting device selects the verification mode, depending on a time necessary to back up the data, as the characteristics.

According to this aspect, depending on the time necessary to back up the data, it is possible to select, for example, the verification mode in which priority is given to reducing the time necessary to back up the data, or the verification mode in which priority is given to improving the reliability of data recording and reading.

In another aspect of the recording apparatus of the present invention, the selecting device selects the verification mode, depending on extent of an influence of the presence of the defect on reading of the data, as the characteristics.

According to this aspect, if the presence of the defect has a small influence on the data reading, it is possible to select the verification mode in which priority is given more to reducing the time necessary to back up the data than to improving the reliability of data recording and reading. Alternatively, if the presence of the defect has a great influence on the data reading, it is possible to select the verification mode in which priority is given more to improving the reliability of data recording and reading than to reducing the time necessary to back up the data.

In another aspect of the recording apparatus of the present invention, the selecting device selects the verification mode so as to average a backup time of the data.

According to this aspect, no matter which data is backed up, the time necessary for the backup can be averaged. Namely, no matter which data is backed up, the backup can be finished within a certain period of time. Thus, it is possible to create an environment for a user to freely perform the backup. in another aspect of the recording apparatus of the present invention, it is further provided with an external specifying device for specifying the verification mode from exterior, the controlling device controlling the verifying device to verify the presence or absence of the defect in the verification mode specified by the external specifying device.

According to this aspect, the verification mode can be selected in response to a user's instruction or the like using the external specifying device. Therefore, depending on the user's preference, it is possible to select, for example, the verification mode in which priority is given to reducing the time necessary to back up the data, or the verification mode in which priority is given to improving the reliability of data recording and reading.

In another aspect of the recording apparatus of the present invention, a specification flag for specifying the verification mode is recorded on the another recording medium, and the controlling device controls the verifying device to verify the presence or absence of the defect in the verification mode specified by the specification flag.

According to this aspect, the specification flag is referred to, whereby priority can be given to, for example, reducing the time necessary to back up the data, or improving the reliability of data recording and reading, with respect to each recording medium for backup.

In another aspect of the recording apparatus of the present invention, it is further provided with a storing device for storing therein association information between the characteristics of the data to be backed up and the verification mode used in backing up the data, the selecting device selecting the verification mode on the basis of the stored association information.

According to this aspect, the selecting device is operable to select the verification mode, relatively easily and properly, on the basis of the association information.

In another aspect of the recording apparatus of the present invention, the verification mode includes at least one of a complete mode in which the presence or absence of the defect is verified in the entire recording area in which the data is backed up, a real-time mode in which the presence or absence of the defect is verified in a recording area in which control information for controlling at least one of recording and reproduction of the data is recorded, out of the recording area in which the data is backed up, and an off mode in which the presence or absence of the defect is not verified in the entire recording area in which the data is backed up.

According to this aspect, for example, the off mode is selected if priority is given to reducing the time necessary to back up the data, and the complete mode is selected if priority is given to improving the reliability of data recording and reading, and the real-time mode is selected if priority is given to both reducing the time necessary to back up the data and improving the reliability of data recording and reading. Therefore, depending on the characteristics of the data to be recorded, the backup can be performed, more preferably.

In another aspect of the recording apparatus of the present invention, the selecting device dynamically selects the verification mode during the backup of the data performed by the recording device, and the controlling device dynamically controls the verifying device during the backup of the data performed by the recording device.

According to this aspect, even during the backup of one data, the aspect of the verification performed by the verifying device can be changed, as occasion demands. Therefore, in the backup of the data, it can be changed, as occasion demands, whether priority is given to reducing the time necessary to back up the data or to improving the reliability of data recording and reading.

(Recording Method)

The above object of the present invention can be also achieved by a recording method provided with: a backup process of backing up data recorded on one recording medium onto another recording medium; a verifying process of verifying presence or absence of a defect in at least a recording area in which the data is backed up, out of the another recording medium; a selecting process of selecting a verification mode used in verifying the presence or absence of the defect, depending on characteristics of the data to be backed up; and a controlling process of controlling the verifying process to verify the presence or absence of the defect in the selected verification mode.

According to the recording method of the present invention, it is possible to receive the same various benefits as those of the above-mentioned recording apparatus of the present invention.

Incidentally, in response to the various aspects of the above-mentioned recording apparatus of the present invention, the recording method of the present invention can also adopt various aspects.

(Computer Program)

The above object of the present invention can be also achieved by a computer program for recording control to control a computer provided in above-mentioned recording apparatus of the present invention (including its various aspects), the computer program making the computer function as at least one portion of the backup device, the verifying device, the selecting device, and the controlling device.

According to the computer program of the present invention, the above-mentioned recording apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects of the above-mentioned recording apparatus of the present invention, the computer program of the present invention can also adopt various aspects.

The above object of the present invention can be also achieved by a computer program product of instructions for recording control and for tangibly embodying a program of instructions executable by a computer provided in the recording apparatus of the present invention (including its various aspects), the computer program product making the computer function as at least one portion of the backup device, the verifying device, the selecting device, and the controlling device.

According to the computer program product of the present invention, at least one portion of the backup device, the verifying device, the selecting device, and the controlling device of the present invention described above can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function at least one portion of the backup device, the verifying device, the selecting device, and the controlling device of the present invention described above.

These effects and other advantages of the present invention will become more apparent from the following embodiments.

As explained above, according to the recording apparatus of the present invention, it is provided with the backup device, the verifying device, the selecting device, and the controlling device, and according to the recording method of the present invention, it is provided with the backup process, the verifying process, the selecting process, and the controlling process. Therefore, the backup can be quickly performed, with increasing the reliability of data recording and reading.

### BRIEF DESCRIPTION OF DRAWINGS

FIG. 1 is a block diagram conceptually showing the basic structure of a recording/reproducing apparatus which is an embodiment of the recording apparatus of the present invention.

FIG. 2 is a block diagram conceptually showing the inner structure of a disc drive provided for the recording/reproducing apparatus in the embodiment.

FIG. 3 is a block diagram conceptually showing the inner structure of a backend provided for the recording/reproducing apparatus in the embodiment.

FIG. 4 is a flowchart conceptually showing a flow of an entire back up operation of the recording/reproducing apparatus in the embodiment.

FIG. 5 are data structure diagrams conceptually showing aspects of the back up operation of the recording/reproducing apparatus in the embodiment.

FIG. 6 are data structure diagrams conceptually showing aspects of a defect verification operation of the recording/reproducing apparatus in the embodiment.

FIG. 7 is a data structure diagram showing defect management information used in the defect verification operation of the recording/reproducing apparatus in the embodiment.

FIG. 8 is an explanatory diagram conceptually showing more specific one operation example when the backup operation is performed on the recording/reproducing apparatus in the embodiment.

FIG. 9 is an explanatory diagram conceptually showing more specific another operation example when the backup operation is performed on the recording/reproducing apparatus in the embodiment.

FIG. 10 is an explanatory diagram conceptually showing more specific another operation example when the backup operation is performed on the recording/reproducing apparatus in the embodiment.

FIG. 11 is an explanatory diagram conceptually showing more specific another operation example when the backup operation is performed on the recording/reproducing apparatus in the embodiment.

FIGS. 12 are data structure diagrams conceptually showing mode memory information used in a modified operation example of the recording/reproducing apparatus in the embodiment.

FIG. 13 is an explanatory diagram showing an aspect in which the mode memory information is recorded onto an optical disc.

### DESCRIPTION OF REFERENCE CODES

100 optical disc

110 mode memory information

120 defect management information

200 recording/reproducing apparatus

300 disc drive

352 optical pickup

359 defect detection device

360 management information generation device

361 CPU

362 defect management mode selector

400 backend host

452 system control device

455 hard disk

### BEST MODE FOR CARRYING OUT THE INVENTION

Hereinafter, the best mode for carrying out the invention will be explained in order in each embodiment with reference to the drawings.

(1) Basic Structure

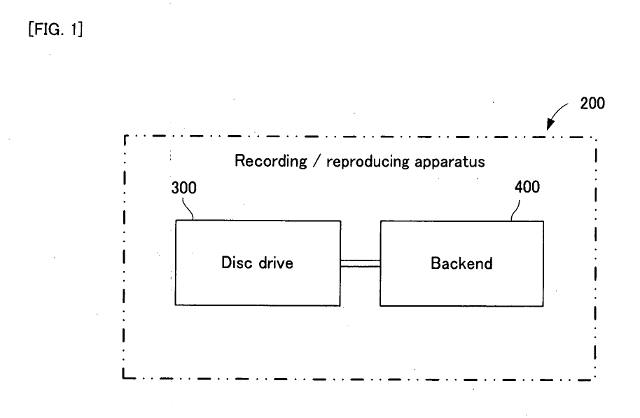

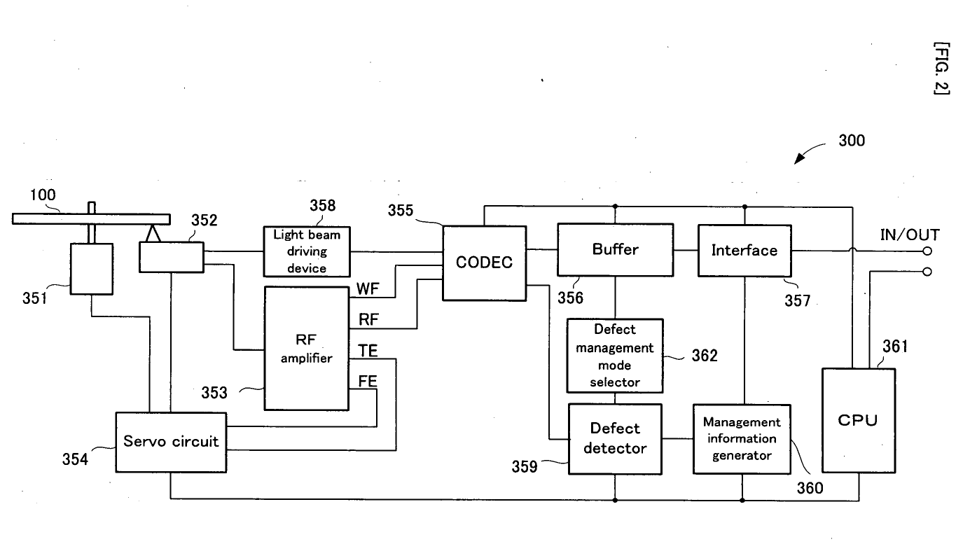

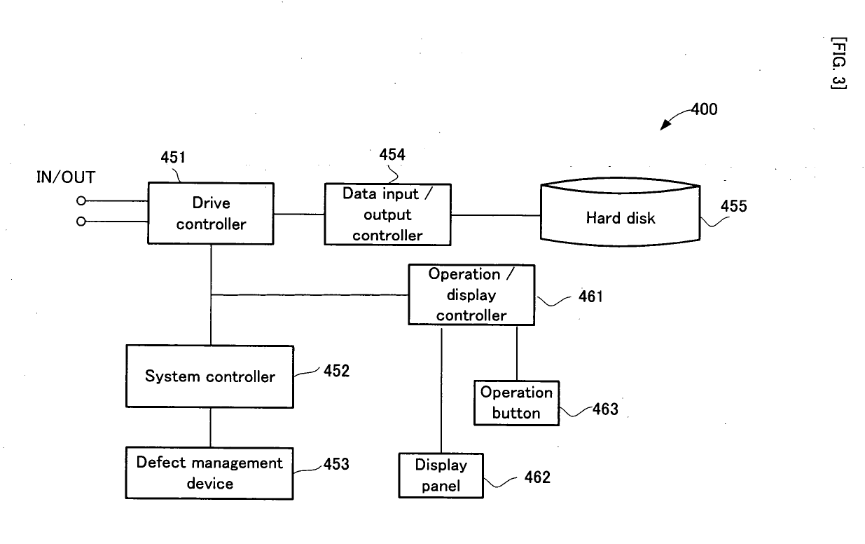

Firstly, with reference to FIG. 1 to FIG. 3, an explanation will be given for the basic structure of an embodiment associated with the recording apparatus of the present invention. FIG. 1 is a block diagram conceptually showing the basic structure of a recording/reproducing apparatus 200 which is an embodiment of the recording apparatus of the present invention. FIG. 2 is a block diagram conceptually showing the inner structure of a disc drive 300 provided for the recording/reproducing apparatus 200. FIG. 3 is a block diagram conceptually showing the inner structure of a backend host 400 provided for the recording/reproducing apparatus 200. Incidentally, the recording/reproducing apparatus 200 has a function of recording data onto an optical disc 100 and a function of reading the data recorded on the optical disc 100.

As shown in FIG. 1, the information recording/reproducing apparatus 200 is provided with: a disc drive 300 on which the optical disc 100 which constitutes one specific example of “another recording medium” of the present invention is actually loaded and on which data recording and data reproduction is performed; and a backend host 400 for controlling the data recording and the data reproduction on the disc drive 300. The backend host 400 corresponds to a host computer, for example, a personal computer or the like.

As shown in FIG. 2, the disc drive is provided with: a spindle motor 351; an optical pickup 352; a RF amplifier 353; and a servo circuit 354.

The spindle motor 351 is a motor for rotating the optical disc 100.

The optical pickup 352 constitutes one specific example of the “backup device” of the present invention, and it is an apparatus for recording data or the like onto a recording surface by irradiating the recording surface of the optical disc 100 with a light beam, and for reading the data or the like recorded on the recording surface by receiving the reflected light of the light beam. The optical pickup 342 outputs a RF signal corresponding to the reflected light of the light beam.

The RF amplifier 353 amplifies the RF signal outputted from the optical pickup 352 and outputs it to a CODEC (i.e., coder/decoder) 355. Moreover, the RF amplifier 353 makes, from the RF signal, a wobble frequency signal WF, a track error signal TE, and a focus error signal FE, and outputs them.

The servo circuit 354 is a servo control circuit for controlling the operations of the optical pickup 352 and the spindle motor 351 on the basis of the track error signal TE, the focus error signal FE, and other servo control signals.

Moreover, as shown in FIG. 2, the disc drive 300 is provided with: the CODEC 355; a buffer 356; an interface 357; and a light beam driving device 358.

The CODEC 355 is a circuit, provided with: a function of performing an error correction on the data in reading; and a function of appending an error correction code or mark to the data in recording and modulating the data. Specifically, the CODEC 355 demodulates and decodes the RF signal outputted from the RF amplifier 353 in reading, performs an error correction on the decoded RF signal, and then outputs this to the buffer 356. Moreover, if the error correction is incapable or if the number of error-corrected codes exceeds a certain reference value as a result of performing the error correction on the decoded RF signal, the CODEC 355 generates an error signal for indicating that, and outputs this signal to a defect detector 359. In recording, the CODEC 355 appends the error correction code to the record data outputted from the buffer 356, modulates this data to have a code suited to the optical characteristics or the like of the optical disc 100, and then outputs the modulated data to the light beam driving device 358.

The buffer 356 is a memory circuit for storing the data temporarily.

The interface 357 is a circuit for controlling the input/output or communication of the data or the like between the disc drive 300 and the backend host 400. Specifically, in reproducing, the interface 357 outputs the data outputted from the buffer 356 (i.e. the data read from the optical disc 100) to the backend host 400, according to a request command from the backend host 400. In recording, the interface 357 receives the data which is inputted from the backend host 400 to the disc drive 300, and outputs this data to the buffer 356. The interface 357 outputs all or part of the defect list maintained in a defect management information generator 360(DMI generator 360) to the backend host 400, according to a request command from the backend host 400.

At the time of recording, the light beam driving device 358 generates a light beam driving signal corresponding to the data outputted from the CODEC 355 and outputs this signal to the optical pickup 352. The optical pickup 352 modulates a light beam on the basis of the light beam driving signal and irradiates it onto the recording surface of the optical disc 100. This causes the recording of data or the like on the recording surface.

Moreover, as shown in FIG. 2, the disc drive 300 is provided with: the defect detector 359; the DMI generator 360; and a defect management mode selector 362.

The defect detector 359 constitutes one specific example of the “verifying device” of the present invention, and it is a circuit for detecting a defect on the optical disc 100. The defect detector 359 generates a defect detection signal for indicating the presence or absence of a defect, and outputs this signal. The defect detector 359 detects a defect on the basis of the result of the data error correction in reading information (in verifying or reproducing). As described above, if the error correction is incapable or if the number of error-corrected codes exceeds the certain reference value as a result of performing the error correction on the decoded RF signal, the CODEC 355 generates the error signal for indicating the fact, and outputs this signal to the defect detector 359. The defect detector 359 outputs the defect detection signal for indicating the presence of a defect when receiving this error signal.

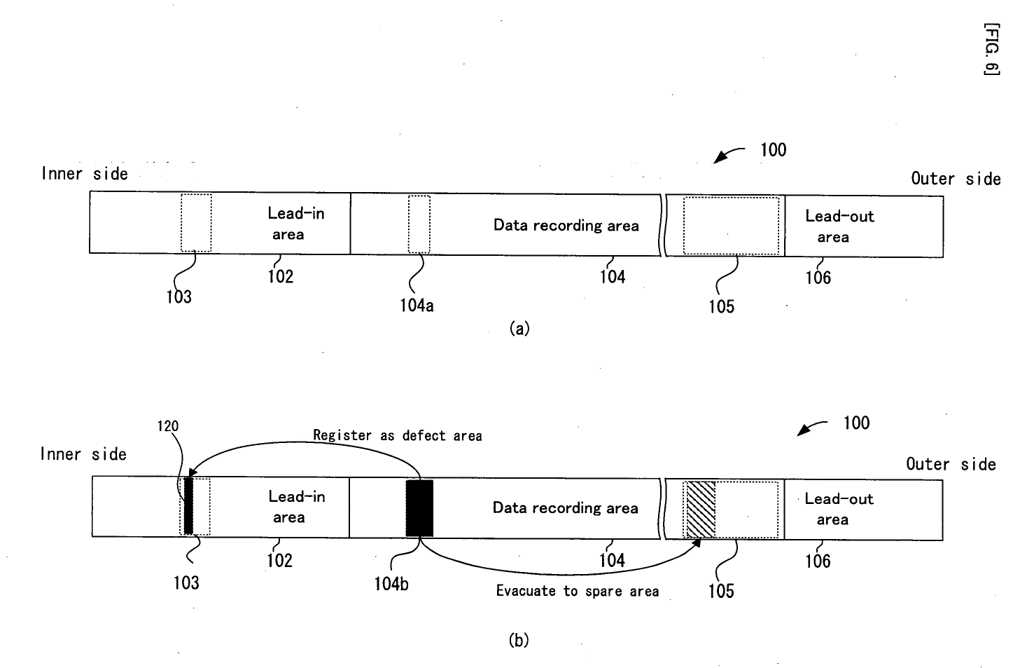

The DMI generator 360 is a circuit for generating or updating defect management information 120 described later (refer to FIG. 7) on the basis of the defect detection signal outputted from the defect detector 359. The defect management information 120 is rewritably stored into a memory circuit placed in the DMI generator 360. The DMI generator 360 responds to a request command from the backend host 400 and outputs the defect management information 120 to the backend host 400 through the interface 357.

The defect management mode selector 362 constitutes one specific example of the “selecting device” of the present invention, and it is a circuit for selecting a management mode for defining the defect detection operation performed by the defect detector 359. For example, it is constructed to select one of the three defect management modes (i.e. one specific example of the “verification mode” of the present invention) defined in ANSI MMC (American National Standard Institutes Multimedia Command Set), as described later, and to output a command to the defect detector 359 so as to perform the defect detection operation on the basis of the selected management mode.

Along with this, the defect detector 359 is constructed to detect a defect in accordance with each of the three defect management modes defined in ANSI MMC, under the control of a CPU 361, which constitutes, for example, one specific example of the “controlling device” of the present invention. Incidentally, these defect management modes will be discussed in detail later.

Moreover, as shown in FIG. 2, the disc drive 300 is equipped with the CPU 361. The CPU 361 controls the disc drive 300 as a whole, and controls the exchange of information among the elements in the disc drive 300 described above. The CPU 361 also controls the recording operation and the reading operation of the data and the defect management information 120. The CPU 361 responds to a control command or a request commend transmitted from the backend host 400 and controls the exchange of data between the disc drive 300 and the backend host 400.

FIG. 3 shows the inner structure of the backend host 400. The backend host 400 is an apparatus for reproducing the data read from the optical disc 100 by the disc drive 300, receiving the data supplied from the exterior or the attached hard disk 455 for the purpose to record it onto the optical disc 100, and transmitting it to the disc drive 300.

The backend host 400 is provided with: a drive controller 451; a system controller 452; a defect management device 453; a data input/output controller 454; a hard disk 455; an operation/display controller 461; a display panel 462; and an operation button 463 which constitutes one specific example of the “external specifying device” of the present invention.

The drive controller 451 is a circuit for controlling the reading processing and recording processing of the disc drive 300. The backend host 400 and the disc drive 300 cooperate and perform an operation of reading the data from the optical disc 100 and reproducing it and an operation of receiving the data from the exterior and recording it onto the optical disc 100. The drive controller 451 realizes the cooperation between the backend host 400 and the disc drive 300 by controlling the reading processing and recording processing of the disc drive 300. Specifically, the drive controller 451 outputs to the disc drive 300 request commands about reading, recording, outputting the data from the buffer 356, outputting the defect management information 120 from the DMI generator 360, and so on. The drive controller 451 also controls the input and output of the data, the defect management information 120, and other various information.

In reproducing, the system controller 452 controls: the drive controller 451; the defect management device 453; the data input/output controller 454; and the operation/display controller 461 or the like, to thereby reproduce the data in cooperation with these devices. In recording, the system controller 452 controls: the drive controller 451; the defect management device 453; the data input/output controller 454; and the operation/display controller 461 or the like, to thereby record the data in cooperation with these devices. In reproducing and recording, the system controller 452 controls the disc drive 300 (e.g. controls the generation and transmission of various request commands, the reception of a response signal, or the like) with the drive controller 451, in order to realize the cooperation between the disc drive 300 and the backend host 400.

The defect management device 453 has therein a memory circuit and has a function of receiving and maintaining all or part of the defect management information 120 generated or updated by the DMI generator 360 in the disc drive 300. The defect management device 453 performs the defect management with the system controller 451.

The data input/output controller 454 controls the input/output of the data from the exterior of the backend host 400 or from the hard disk 455, and performs storage and export with respect to a buffer on a not-illustrated memory. If the input/output of the data is performed by using a video signal, the received data is compressed (encoded) in a MPEG format and then outputted upon the data input, and the data of the MPEG format received from the memory is decompressed (decoded) and then outputted upon the data output.

The hard disk 455 constitutes one specific example of the “one recording medium” of the present invention, and it is a magnetic recording medium with a recording capacity of, for example, several tens GB. For example, the hard disk 455 is operable to record thereon various data, such as text data prepared by a user of a personal computer, which is one specific example of the backend host 400, image data, and motion picture data.

The operation/display controller 461 receives an operation instruction with respect to the recording/reproducing apparatus 200 and performs a display operation. The operation/display controller 461 sends a recording or reproduction instruction performed by using an operation button 463, to the system controller 452, and outputs the operational state of the recording/reproducing apparatus 200, such as during recording and during reproduction, to the display panel 462, such as a liquid crystal display and a fluorescent tube.

In household equipment, one example of the recording/reproducing apparatus 200 is recorder equipment for recording/reproducing video images. The recorder equipment records a video signal from a broadcast reception tuner and an external connecting terminal onto a disc, and outputs the video signal reproduced from the disc to external display equipment, such as a television.

(2) Operation Principle

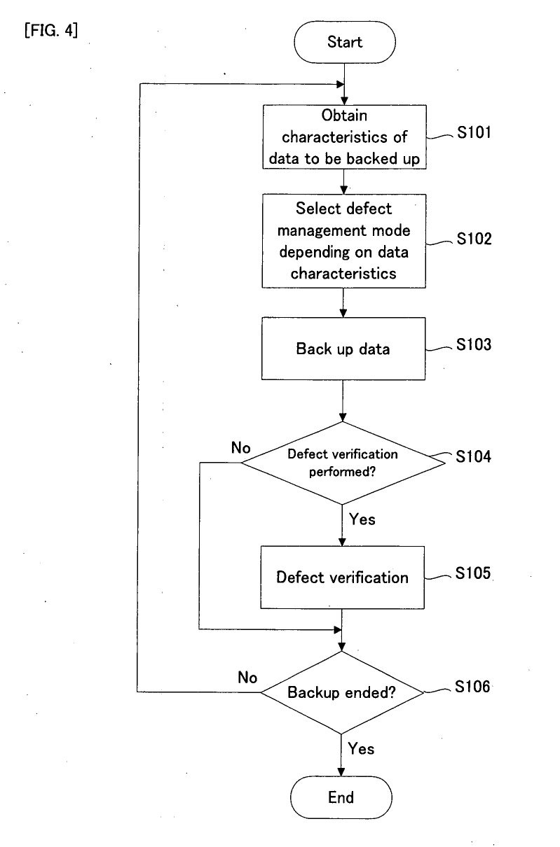

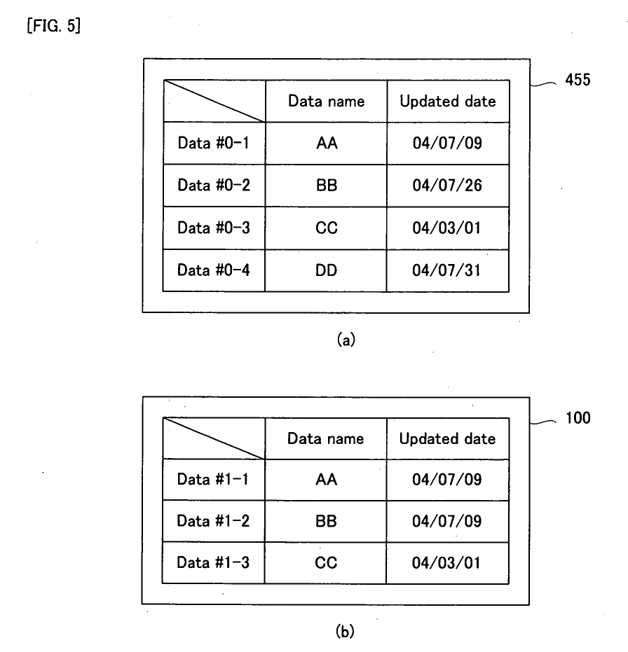

Next, with reference to FIG. 4 to FIG. 7, the basic operation principle of the recording/reproducing apparatus 200 in the embodiment will be explained. FIG. 4 is a flowchart conceptually showing a flow of the entire back up operation of the recording/reproducing apparatus 200. FIGS. 5 are data structure diagrams conceptually showing aspects of the back up operation. FIGS. 6 are data structure diagrams conceptually showing aspects of a defect verification operation. FIG. 7 is a data structure diagrams showing defect management information used in the defect verification operation.

Incidentally, in the embodiment, an explanation will be given for the backup operation of copying the data recorded on the hard disk 455 onto an optical disc, out of the operations performed by the recording/reproducing apparatus 200. Of course, these are not explained below, but obviously, the operation of recording data onto the hard disk 455 and the operation of recording data onto the optical disc 100 can be also performed as in a normal recording/reproducing apparatus.

Firstly, before the backup operation, the optical disc 100 is loaded on the disc drive 300. At this time, various control information recorded in a lead-in area or the like of the optical disc 100 may be read, to thereby set various parameters necessary for the data backup operation (i.e. recording operation), or OPC (Optimum Power Control) may be performed to set the power of laser light.

Then, as shown in FIG. 4, under the control of the CPU 361 or the system controller 452, the characteristics of the data (or file) to be backed up is obtained (step S101). Specifically, the data size, data type, and intended purpose or the like of the data to be backed up (various data, for example, text data, word processor document data, image data, motion picture data, audio data, drawing data, management data, and so on) are obtained as the data characteristics. Moreover, a time necessary for the backup when at least one of the three defect management modes defined in ANSI MMC is used for the backup, is also obtained as the data characteristic.

Here, it may be constructed such that all the data recorded on the hard disk 455 is backed up; however, preferably, one portion of the data recorded on the hard disk 455 as shown in FIGS. 5 is selectively backed up. If all the data is backed up, it is necessary to obtain the characteristics of all the data. If one portion of the data is selectively backed up, it is only necessary to obtain the characteristics of one portion of the data. A more detailed explanation will be given for the aspect in which one portion of the data is selectively backed up, with reference to FIGS. 5.

For example, it is assumed that the data shown in FIG. 5(a) is recorded on the hard disk 455, which is a backup source; namely, data #0-1 whose data name is “AA” and whose updated date (i.e. last date when the data is recorded on the hard disk 455) is “Jul. 9, 2004”, date #0-2 whose data name is “BB” and whose updated date is “Jul. 26, 2004”, date #0-3 whose data name is “CC” and whose updated date is “Mar. 1, 2004”, and date #0-4 whose data name is “DD” and whose updated date is “Jul. 31, 2004”.

On the other hand, it is assumed that the data shown in FIG. 5(b) is recorded on the optical disc 100, which is a backup destination; namely, data #1-1 whose data name is “AA” and whose updated date is “Jul. 9, 2004”, date #1-2 whose data name is “BB” and whose updated date is “Jul. 9, 2004”, and date #1-3 whose data name is “CC” and whose updated date is “Mar. 1, 2004”.

Now, the data #0-1 recorded on the hard disk 455 and the data #1-1 recorded on the optical disc 100 are judged to be identical data because they have the same data name and the same updated date. Therefore, it is judged that it is unnecessary to back up the data #0-1 recorded on the hard disk 455. In the same manner, it is judged that it is unnecessary to back up the data #0-3 recorded on the hard disk 455.

On the other hand, the data #0-2 recorded on the hard disk 455 and the data #1-2 recorded on the optical disc 100 have the same data name but have different updated dates. In particular, the updated date of the data #0-2 recorded on the hard disk 455 is newer than that of the data #1-2 recorded on the optical disc 100. Thus it is judged that the data with the data name of “BB” is updated again after it is backed up onto the optical disc 100. Therefore, it is judged that it is necessary to back up the data #0-2 onto the optical disc 100.

Moreover, data with the same data name of “DD” as that of the data #0-4 recorded on the hard disk 455 is not recorded on the optical disc 100. Thus, it is judged that the data #0-4 is data newly generated after the data is backed up onto the optical disc 100. Therefore, it is judged that it is necessary to back up the data #0-4 onto the optical disc 100.

As described above, if there is the data updated again or newly generated after the back up onto the optical disc 100 is performed, preferably, such data is selectively extracted and backed up. The data that is not updated after it is backed up onto the optical disc 100 is not necessarily backed up again. By performing such a backup operation, the data recorded on the hard disk 455 can be backed up onto the optical disc 100, more efficiently and quickly.

In FIG. 4 again, then, the defect management mode, which defines a verification aspect when the presence or absence of the defect is verified in the backup operation, is selected (step S102). In particular, the defect management mode is selected on the basis of the data characteristics obtained in the step S101. More specifically, in view of the time necessary for the backup and the importance of the data to be backed up or the like, the appropriate defect management mode is selected so that the data is backed up quickly, with increasing the reliability of data recording and reading.

The defect management mode will be explained in detail. For example, in ANSI MMC, three defect management modes are defined, which are a complete mode, a real-time mode, and an off mode.

The complete mode is a defect management mode of verifying the presence or absence of the defect in all the recording areas (specifically, sectors) in which the data is recorded, after the data recording. Namely, according to the complete mode, the presence or absence of the defect is verified in all the recording areas in which both the data to be recorded on the basis of a recording command of the disc drive 300 and the data to be recorded on the basis of a recording command of a file system which operates on the system controller 452 of the backend host 400 are recorded. Moreover, in the complete mode, the presence or absence of the defect is verified in advance, in the recording area in which the data will be recorded, before the data recording. Therefore, if the defect management is performed in the complete mode, there is such an advantage that the reliability of data recording and reading is greatly improved. On the other hand, there is also such a disadvantage that a time necessary to verify the presence or absence of the defect (which is eventually the time necessary to back up the data) is greatly increased.

The real-time mode is a defect management mode of selectively verifying the presence or absence of the defect in the recording area in which the control information, such as file system information, is recorded. Specifically, the presence or absence of the defect is verified in the recording area in which the control information or the like necessary for the recording/ reproduction of various contents is recorded. However, it is not verified in the recording area in which the entity information (e.g. real-time content data, etc.) of various contents is recorded. In particular, reading is performed in the recording area in which the control information or the like will be recorded before it is actually recorded. Thus, the presence or absence of the defect can be verified by using the reading result. Therefore, if the defect management is performed in the read-time mode, the reliability of recording and reading of the control information can be improved, and the time necessary to verify the presence or absence of the defect (which is eventually the time necessary to back up the data) can be reduced more than in the complete mode.

In particular, an optical disc on which data can be recorded a plurality of times in the same recording area, like a DVD-RW, a CD-RW, a BD-RW (Blu-ray Disc Rewritable) and so on, has such a technical problem that the recording area deteriorates if the data is repeatedly recorded or read in the same recording area. In this case, if the defect management is performed in the real-time mode, the presence or absence of the defect can be verified by using the result of the reading performed before the recording of the control information. Thus, the number of reading times in the recording area can be reduced, to thereby inhibit the progression of deterioration. Moreover, with regard to the entity information or the like, the presence or absence of the defect is not verified. Thus, the number of reading times can be reduced, to thereby inhibit the progression of deterioration.

The off mode is a defect management mode of not verifying the presence or absence of the defect. Therefore, if the defect management is performed in the off mode, there is such a disadvantage that the reliability of data recording and reading is not improved. On the other hand, there is such an advantage that a time necessary for the data recording can be reduced more greatly than in the complete mode and the like.

Then, the data is actually backed up onto the optical disc 100 (step S103). Specifically, as described above, the data newly updated or generated out of the data recorded on the hard disk 455 is selectively backed up onto the optical disc 100.

Simultaneously with the backup operation, or after the backup operation, or every time the data portion of a predetermined unit (e.g. sector unit) is backed up, it is judged whether or not to verify the presence or absence of the defect (step S104). The judgment here is performed on the basis of the defect management mode selected in the step S102. For example, if the complete mode and the real-time mode are selected for the data (or data portion) which is backed up, it is judged that the presence or absence of the defect is verified. On the other hand, if the off mode is selected for the data (or data portion) which is backed up, it is judged that the presence or absence of the defect is not verified.

As a result of the judgment, if it is judged that the presence or absence of the defect is verified (the step S104: Yes), the presence or absence of the defect is actually verified (step S105), and the defect management information 120 is generated if necessary, to thereby perform the defect management. Here, particularly, the presence or absence of the defect is verified in the aspect based on the defect management mode selected in the step S102. Namely, if the complete mode is selected, the presence or absence of the defect is verified in all the recording areas in which the data is backed up. On the other hand, if the real-time mode is selected, the presence or absence of the defect is selectively verified in the reading area in which the control information or the like is backed up, out of the backed-up data. Then, the operational flow goes to a step S106.

Now, the aspect of the defect management operation in a case where it is judged that there is the defect from the verification of the presence or absence of the defect will be explained in more detail, with reference to FIGS. 6 and FIG. 7.

As shown in FIG. 6(a), it is assumed that data is backed up into an area 104a out of a data recording area 104 provided on the optical disc 100. At this time, the data backed up in the area 104a is read (verified), and it is judged whether the error correction is incapable, or whether or not the number of error-corrected codes exceeds a certain reference value. As a result, if it is judged that there is the defect in the area 140a, as shown in FIG. 6(b), the area 104b is registered as a defect area. Specifically, the defect management information 120 indicating that the area 104a is the defect area is recorded into a defect management area 103 in a lead-in area 102 provided on the optical disc 100. In addition, the data to be originally backed up into the area 104a is recorded into a spare area 105 provided on the optical disc 100.

FIG. 7 is a data structure diagrams showing one specific example of the defect management information 120. As shown in FIG. 7, in the defect management information 120, there are recorded a defect area address and a spare area address.

The defect area address indicates the address of the defect area (i.e. the area 104a in FIG. 6).

The spare area address indicates the address of the spare area 105 into which the data backed up in the defect area or to be backed up is recorded. The spare area 105 may be provided in the data recording area 104, as shown in FIG. 6(a) and FIG. 6(b), or may be provided in a lead-out area 106 (or the lead-in area 102).

Moreover, a unit including one defect area address and one spare are address is referred to as an entry. For example, the entry described on the top of the defect management information 120 shown in FIG. 7 indicates that the address of the area 104a in which the defect is generated is “AAAAh” and that the data backed up thereto or to be backed up is recorded in the spare area 105 with an address of “EFF0h”. Moreover, the next entry described indicates that the address of an area in which the defect is generated is “BBBBh” and that the data backed up thereto or to be backed up is recorded in the spare area 105 with an address of “FFF0h”.

As described above, by performing the defect management with generating the defect management information 120, even if there is the defect on the optical disc 100, the data can be preferably read without influence of the defect, by reading the data recorded in the spare area 105.

In FIG. 4 again, if it is judged that the presence or absence of the defect is not verified (the step S104: No), the operational flow goes to a step S106, and it is judged whether or not the backup operation is ended (step S106). Namely, it is judged whether or not the backup operation for all the data to be backed up is ended As a result of the judgment, if it is judged that the backup operation is ended (the step S106: Yes), then the backup operation is ended, and the optical disc 100 is ejected from the disc drive 300 if necessary. On the other hand, if it is judged that the backup operation is not ended (the step S106: No); namely, if it is judged that another data will be backed up, then the operational flow returns to the step S101 again, and the above-mentioned operation is repeated.

(3) Specific Operation Example

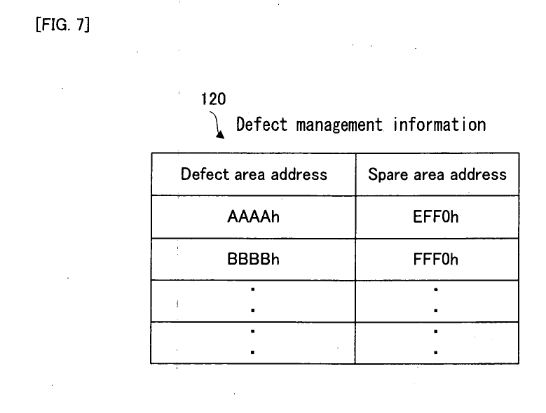

Next, with reference to FIG. 8 to FIG. 11, an explanation will be given for a more specific operation example when the recording/reproducing apparatus 200 actually performs the backup operation. Each of FIG. 8 to FIG. 11 is an explanatory diagram conceptually showing a more specific operation example when the backup operation is performed.

As shown in FIG. 8, it is assumed that business data (e.g. relatively highly important data) and private data (e.g. relatively less important data) are recorded on the hard disk 455. When these data are backed up, in the step S102 in FIG. 4, the complete mode is selected for the business data, and the off mode or the real-time mode is selected for the private data. Namely, the defect management mode is selected in view of whether the data is for business or for private (or relatively highly important or less important), as the characteristics of the data to be backed up.

Consequently, with regard to the business data (or relatively highly important data), priority is given to increasing the reliability of data recording and reading. On the other hand, with regard to the private data (or relatively less important data), priority is given to reducing the time necessary for the backup. Thus, the time necessary to back up all the data can be reduced more greatly than the case where the complete mode is selected for all the data, while increasing the reliability of the recording and reading of the relatively highly important data.

Moreover, as shown in FIG. 9, it is assumed that data #1 with a data size of 10G B and data #2 with a data size of 50 MB are recorded on the hard disk 455. When these data are backed up, in the step S102 in FIG. 4, the off mode or the real-time mode is selected for the data #1, and the complete mode or the real-time mode is selected for the data #2. Namely, the defect management mode is selected in view of whether the data size is relatively large or small, as the characteristics of the data to be backed up. For example, the off mode is selected for the data with a data size larger than a certain first threshold value (e.g. 5 GB), the real-time mode is selected for the data with a data size smaller than the first threshold value and larger than a certain second threshold value (e.g. 700 MB), and the complete mode is selected for the data with a data size smaller than the second threshold value. In other words, the defect management mode is selected in view of the time necessary to back up each data, as the characteristics of the data to be backed up. For example, such a defect management mode that the presence or absence of the defect can be verified so that the time necessary for the backup is not over a predetermined period of time (e.g. 1 hour) is selected.

Consequently, with regard to the data with a relatively large data size, priority is given to reducing the time necessary for the backup. On the other hand, with regard to the data with a relatively small data size, priority is given to increasing the reliability of data recording and reading, because the time necessary for the backup is short in the nature. Thus, the time necessary to back up all the data can be reduced more greatly than the case where the complete mode is selected for all the data, while appropriately increasing the reliability of data recording and reading. Moreover, on the basis of the data size, which can be easily recognized by the recording/reproducing apparatus 200, the defect management mode can be preferably selected even if the above-mentioned intended purpose of the data and a data type described later cannot be recognized. Moreover, it may be constructed to select the defect management mode so as to average the time necessary to back up the data, depending on the data size (e.g. so as to back up the data in about 30 min in a CD, about 1-2 hours in a DVD, and about 3 hours in a BD).

Incidentally, regarding the data size and the time necessary for the backup, one example will be given below. For example, in the case where data is backed up onto a CD-RW (10x recording), which is one specific example of the optical disc 100, if the defect management is not performed (i.e. if the defect management is performed in the off mode), the time necessary to back up the data with a data size of about 650 MB is about 10 min. On the other hand, if the defect management is performed in the complete mode, the time necessary to back up the data with a data size of about 650 MB is about 60 min. Namely, the time necessary for the backup when the defect management is performed in the complete mode is about 6 times longer than that when the defect management is not performed.

Moreover, for example, in the case where data is backed up onto a DVD-RW (4x recording), which is one specific example of the optical disc 100, if the defect management is not performed (i.e. if the defect management is performed in the off mode), the time necessary to back up the data with a data size of about 4.2 GB is about 30 min. On the other hand, if the defect management is performed in the complete mode, the time necessary to back up the data with a data size of about 4.2 GB is about 240 min. Namely, the time necessary for the backup when the defect management is performed in the complete mode is about 8 times longer than that when the defect management is not performed.

Moreover, for example, in the case where data is backed up onto a BD-RW (1x recording), which is one specific example of the optical disc 100, if the defect management is not performed (i.e. if the defect management is performed in the off mode), the time necessary to back up the data with a data size of about 27 GB is about 90 min. On the other hand, if the defect management is performed in the complete mode, the time necessary to back up the data with a data size of about 27 GB is about 600 min. Namely, the time necessary for the backup when the defect management is performed in the complete mode is about 7 times longer than that when the defect management is not performed.

As described above, if it is desired to always perform the defect management in the complete mode, the time necessary for the backup is greatly increased, which greatly reduces user's convenience. Under such circumstances, the user is not likely to perform the backup operation. Thus, the recording/reproducing apparatus 200 in the embodiment in which the preferable defect management mode is selected, depending on the time necessary for the backup (i.e. the data size of the data to be backed up), has such a great advantage that the it can improve the user's convenience.

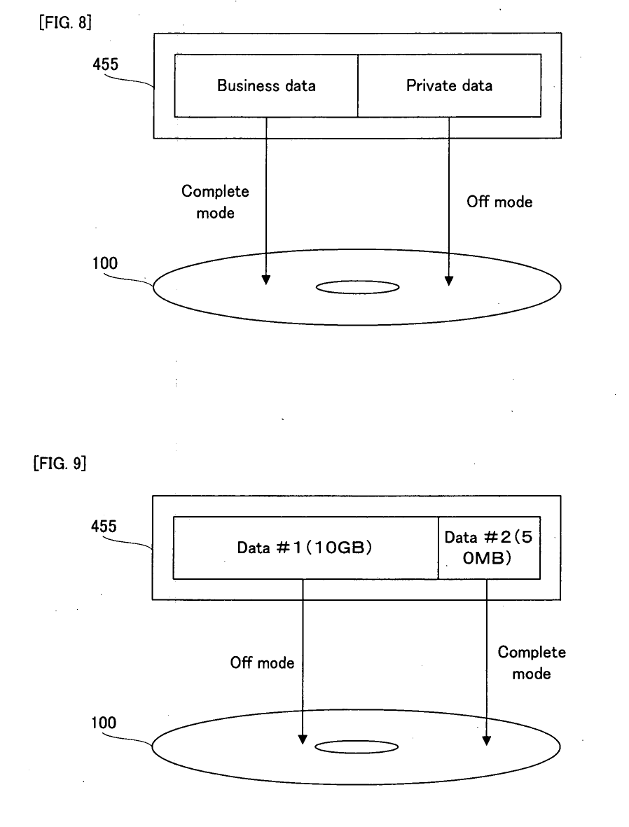

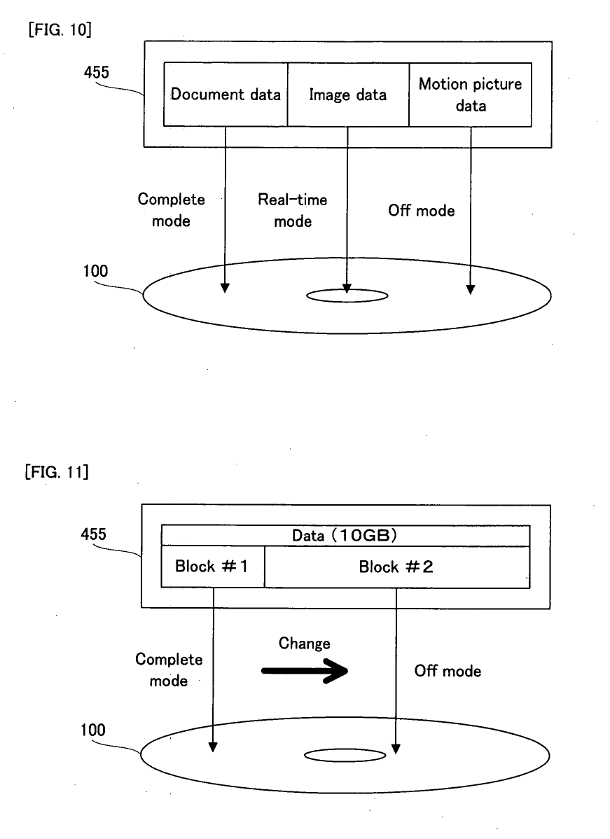

Moreover, as shown in FIG. 10, it is assumed that document data (e.g. text data, word processor data, etc.), image data (e.g. JPEG data, bitmap data, etc.) and motion picture data (e.g. MPEG data, WMV data, etc.) are recorded on the hard disk 455. When these data are backed up, in the step S102 in FIG. 4, the complete mode is selected for the document data, the real-time mode is selected for the image data, and the off mode is selected for the motion picture data. Namely, the defect management mode is selected in view of the data type (file type), as the characteristics of the data to be backed up. Alternatively, the defect management mode is selected in view of extension of the data, as the characteristics of the data to be backed up.

For example, the document data has a relatively small data size, so that the time necessary for the backup is short in the nature. Thus, priority is given to increasing the reliability of data recording and reading. Moreover, the document data has a relatively small data size, so that there is a possibility that even the defect existing in a relatively small recording area has a great influence on the reading and reproduction of the document data. Thus, priority is given more to increasing the reliability of data recording and reading than to reducing the time necessary for the backup.

Moreover, the motion picture data has a relatively large data size, so that priority is given more to reducing the time necessary for the backup than to increasing the reliability of data recording and reading. Furthermore, the motion picture data has a relatively large data size, so that the defect existing in a relatively small recording area has little influence on the reading and reproduction of the motion picture data. For example, in many cases, the influence is nearly equal to that of noise appearing for a moment in a normal motion picture. Therefore, priority is given more to reducing the time necessary for the backup than to increasing the reliability of data recording and reading.

Consequently, with regard to the document data which has a relatively small data size or in which the presence of the defect has a relatively great influence on the data reading, priority is given more to improving the reliability of data recording and reading than to reducing the time necessary for the backup. Moreover, with regard to the image data which has a relatively large data size or in which the presence of the defect has a slight influence on the data reading, priority is given to both improving the reliability of data recording and reading, and reducing the time necessary for the backup. Moreover, with regard to the motion picture data which has a huge data size or in which the presence of the defect has little influence on the data reading, priority is given more to reducing the time necessary for the backup than to improving the reliability of data recording and reading. Thus, the time necessary to back up all the data can be reduced more greatly than the case where the complete mode is selected for all the data, while appropriately increasing the reliability of data recording and reading.

Moreover, as shown in FIG. 11, it is assumed that 10GB data is recorded on the hard disk 455. When the data is backed up, in the step S102 in FIG. 4, firstly, the complete mode is selected, and one portion of the data is backed up on the optical disc 100. Then, after block data #1, as the one portion of the data, is backed up, if it is judged that a time necessary to back up the entire 10GB data is greater than a predetermined value, the off mode may be newly selected as the defect management mode, and block data #2, which is another portion of the data, may be backed up. Alternatively, after one portion of the data is backed up for a certain time while the defect management is performed in the complete mode, another portion of the data may be backed up while the defect management is performed in the off mode. Namely, in the middle of the backup of the same data, the defect management mode may be dynamically changed, and the backup operation may be continued.

This allows the defect management aspect to be changed, as occasion demands, depending on the backup operation aspect or the like, during the data backup operation. Therefore, the reliability of data recording and reading can be appropriately increased, and the time necessary to back up the data can be reduced. At the same time, the data can be backed up, more efficiently and preferably.

As explained above, according to the recording/reproducing apparatus 200 in the embodiment, the backup operation can be performed with changing the defect management aspect, as occasion demands, or dynamically, depending on the characteristics of the data to be backed up. Therefore, the time necessary to back up the data can be relatively reduced, while increasing the reliability of data recording and reading. Thus, it is possible to realize the environment that a user can easily perform the backup.

Incidentally, in the embodiment, it may be hardware defect management in which the above-mentioned defect management is performed by the operation of the disc drive 300 (mainly, the CPU 361 thereof, or software defect management in which the above-mentioned defect management is performed by the operation of a program executed on the backend host 400 (mainly, the system controller 452 thereof). Moreover, the recording medium is not limited to the hard disk and the optical disc, and an arbitrary recording medium can be used.

Moreover, it is not limited to the above-mentioned three defect management modes, and it may be constructed to select another defect management mode. Moreover, for example, the desired defect management mode may be selected by a user himself, in response to a user's instruction using the instruction button 463 or the like. Furthermore, the user may set the desired defect management mode by himself, and the information recording/reproducing apparatus 200 may select the set defect management mode.

(4) Modified Operation Example

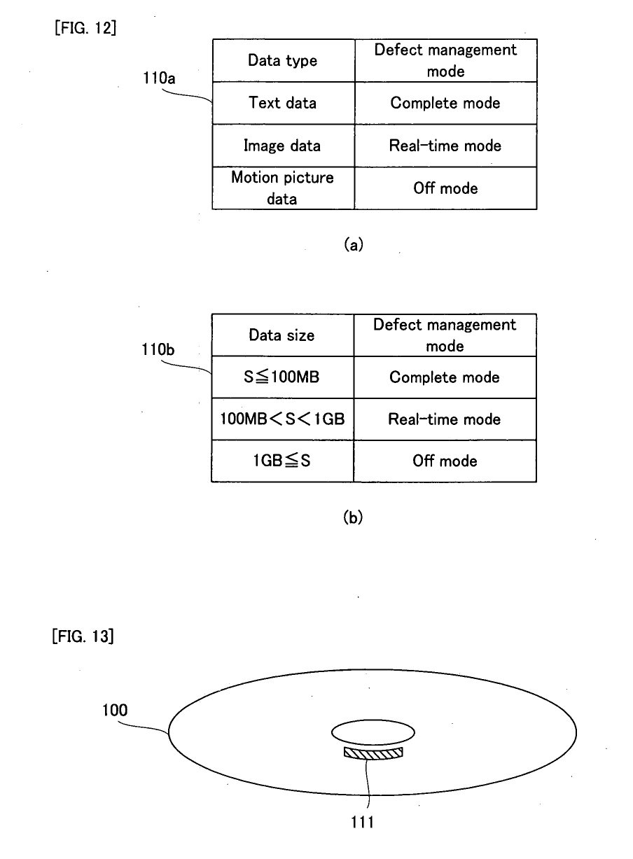

Next, with reference to FIG. 12 and FIG. 13, a modified operation example of the recording/reproducing apparatus 200 in the embodiment will be explained. FIGS. 12 are data structure diagrams conceptually showing mode memory information 110 used in the modified operation example of the recording/reproducing apparatus 200. FIG. 13 is an explanatory diagram showing an aspect in which specification information 111 is recorded onto the optical disc 100.

As shown in FIG. 12(a), it may be constructed to generate mode memory information 110a indicating an association between the data type and the defect management mode. For example, according to the memory information 110a shown in FIG. 12(a), it indicates that if the data type is text data, the complete mode is selected, if the data type is image data, the real-time mode is selected, and if the data type is motion picture data, the off mode is selected.

Alternatively, as shown in FIG. 12(b), it may be constructed to generate mode memory information 110b indicating an association between the data size and the defect management mode. For example, according to the memory information 110b shown in FIG. 12(b), it indicates that if a data size S is 100 MB or less, the complete mode is selected, if the data size S is greater than 100 MB and smaller than 1GB, the real-time mode is selected, and if the data size S is 1GB or more, the off mode is selected.

These mode memory information 110a and 110b may be recorded on the optical disc 100, or recorded on a memory provided for the recording/reproducing apparatus 200. Moreover, the mode memory information 110a and 110b may be generated in advance, or generated in real time on the basis of the defect management mode selected in the actual backup operation. If the mode memory information 110a and 110b is referred to in the selection of the defect management mode in the step S102 in FIG. 4, the defect management mode can be selected, relatively easily.

Moreover, as shown in FIG. 13, if the specification information 111 for specifying the defect management mode to be selected is recorded on the optical disc 100, the recording/reproducing apparatus 200 can select the above-mentioned defect management mode, relatively easily, with reference to the specification information 111. For example, if a certain optical disc 100 is used only for the backup of the business data, the specification information 111 for specifying the selection of the complete mode as the defect management mode is recorded thereon.

Moreover, in the above-mentioned embodiment, the optical disc 100 and the hard disk 455 are explained as one example of the recording medium, and the recorder associated with the optical disc 100 and the hard disk 455 is explained as one example of the recording apparatus. The present invention, however, is not limited to the optical disc and the hard disk, and the recorder thereof, and can be applied to other various recording media which support high-density recording and high transfer rate, and the recorder or player thereof.

The present invention is not limited to the above-mentioned embodiment, and various changes may be made, if desired, without departing from the essence or spirit of the invention which can be read from the claims and the entire specification. A recording apparatus and method, and a computer program for recording control, which involve such changes, are also intended to be within the technical scope of the present invention.

### INDUSTRIAL APPLICABILITY

The recording apparatus and method, and the computer program of the present invention can be applied to a recording apparatus, such as, for example, a DVD recorder. Moreover, they can be applied to a recording apparatus or the like, which is mounted on or can be connected to various computer equipment for consumer use or business use, for example.

1-14. (canceled)

15. A recording apparatus comprising:
a backup device for backing up data recorded on one recording medium onto another recording medium;
a verifying device for verifying presence or absence of a defect in at least a recording area in which the data is backed up, out of the another recording medium;
a selecting device for selecting a verification mode used in verifying the presence or absence of the defect, depending on a size of the data as characteristics of the data to be backed up; and
a controlling device for controlling said verifying device to verify the presence or absence of the defect in the selected verification mode.

16. The recording apparatus according to claim 15, wherein said selecting device selects the verification mode, depending on a data type of the data, as the characteristics.

17. The recording apparatus according to claim 15, wherein said selecting device selects the verification mode, depending on an intended purpose of the data, as the characteristics.

18. The recording apparatus according to claim 15, wherein said selecting device selects the verification mode, depending on a time necessary to back up the data, as the characteristics.

19. The recording apparatus according to claim 15, wherein said selecting device selects the verification mode, depending on extent of an influence of the presence of the defect on reading of the data, as the characteristics.

20. The recording apparatus according to claim 15, wherein said selecting device selects the verification mode so as to average a backup time of the data.

21. The recording apparatus according to claim 15, further comprising an external specifying device for specifying the verification mode from exterior, said controlling device controlling said verifying device to verify the presence or absence of the defect in the verification mode specified by said external specifying device.

22. The recording apparatus according to claim 15, wherein
a specification flag for specifying the verification mode is recorded on the another recording medium, and
said controlling device controls said verifying device to verify the presence or absence of the defect in the verification mode specified by the specification flag.

23. The recording apparatus according to claim 15, further comprising a storing device for storing therein association information between the characteristics of the data to be backed up and the verification mode used in backing up the data,
said selecting device selecting the verification mode on the basis of the stored association information.

24. The recording apparatus according to claim 15, wherein the verification mode includes at least one of a complete mode in which the presence or absence of the defect is verified in the entire recording area in which the data is backed up, a real-time mode in which the presence or absence of the defect is verified in a recording area in which control information for controlling at least one of recording and reproduction of the data is recorded, out of the recording area in which the data is backed up, and an off mode in which the presence or absence of the defect is not verified in the entire recording area in which the data is backed up.

25. The recording apparatus according to claim 15, wherein
said selecting device dynamically selects the verification mode during the backup of the data performed by said backup device, and
said controlling device dynamically controls said verifying device during the backup of the data performed by said backup device.

26. A recording method comprising:
a backup process of backing up data recorded on one recording medium onto another recording medium;
a verifying process of verifying presence or absence of a defect in at least a recording area in which the data is backed up, out of the another recording medium;
a selecting process of selecting a verification mode used in verifying the presence or absence of the defect, depending on a size of the data as characteristics of the data to be backed up; and
a controlling process of controlling said verifying process to verify the presence or absence of the defect in the selected verification mode.

27. A computer program product of instructions for recording control and for tangibly embodying a program of instructions executable by a computer provided in a recording apparatus, the computer program making the computer function as at least one portion of a backup device, a verifying device, a selecting device, and a controlling device,
said recording apparatus comprising:
said backup device for backing up data recorded on one recording_medium onto another recording medium;
said verifying device for verifying presence or absence of a defect in at least a recording area in which the data is backed up, out of the another_recording medium;
said selecting device for selecting a verification mode used in verifying the presence or absence of the defect, depending on a size of the data as characteristics of the data to be backed up; and
said controlling device for controlling said verifying device to verify the presence or absence of the defect in the selected verification mode.
